(19) United States
(12) Patent Application Publication
(10) Pub. No.: US 2012/0043897 A1
(43) Pub. Date: Feb. 23, 2012

(54) LED CIRCUITS AND ASSEMBLIES

(75) Inventors: Michael Miskin, Sleepy Hollow, IL (US); Robert L. Kottritsch, Shefford (GB)

(73) Assignee: Link Labs, Inc., Elgin, IL (US)

(21) Appl. No.: 13/318,463

(22) PCT Filed: Apr. 30, 2010
(86) PCT No.: PCT/US10/01269

§ 371 Date: Nov. 1, 2011

Related U.S. Application Data
(60) Provisional application No. 61/215,144, filed on May 1, 2009.

(51) Int. Cl. H05B 37/02

(52) U.S. Cl. 315/192

(57) ABSTRACT

An AC-driven LED circuit includes a first circuit having a first branch and a second branch which connect at first and second common point The common points provide input and output for an AC driving current from a driver of the circuit The first branch has first LED and second LED, the first LED being connected to second LED in opposing series relationship with the inputs of the first and second LEDs defining a first branch junction A second branch has a third LED and a fourth LED, the third LED is connected to the fourth LED in opposing series relationship with the outputs of the third and fourth LEDs defining a second branch junction Improvement in performance and scalability is provided by adding n diodes to a given basic circuit and x cross connecting circuit branch diodes and providing one or more basic circuits in series and or basic.

### RELATED APPLICATIONS

The application is a continuation-in-part of U.S. patent application Ser. No. 12/287,267, filed Oct. 6, 2008, which claims the priority to U.S. Provisional Application No. 60/997,771, filed Oct. 6, 2007; this application also claims priority to U.S. Provisional Application No. 61/215,144, filed May 1, 2009; the contents of each of these applications are expressly incorporated herein by reference.

### FIELD OF THE INVENTION

The present invention relates generally to light-emitting diode (“LED”) circuits and assemblies; and more specifically to scalable alternating current (“AC”) driven LED circuits and assemblies.

### SUMMARY OF THE INVENTION

While not intending to limit the scope of the claims or disclosure, in brief summary, the present disclosure and claims are directed to providing improved ease of designing and building lighting fixtures using AC-driven LEDs. Disclosed and claimed are LED circuits having scalable circuit configurations and LED package assembly configurations which can be used in an AC-drive platform to more easily match the voltage requirements of the lighting fixture(s) or systems in which the LED's are desired. Circuits and LED package assemblies are claimed and disclosed which reduce objectionable flicker produced from AC-driven LEDs and to produce more light per component. Packaged LED's are provided for lighting design according to the invention which address flicker at low frequencies (e.g. 50/60 Hz) while being scalable as desired for a particular lighting goal without resort to designing individual assemblies at the semiconductor die level. Circuits are also disclosed and claimed which provide for some of the LEDs in a circuit to be on during both positive and negative phases of an AC source, to among other things, address flicker. Also, circuits are claimed and disclosed where a basic circuit design provides a voltage and current performance whereby scalability or matching a particular voltage requirement is achieved by configuring LEDs in the basic design and/or by joining one or more of the basic circuits together in series or basic to achieve the design requirement.

According to an embodiment of the invention an AC-driven LED circuit is proposed having at least a first [basic] circuit comprising LEDs. Each LED has an input and an output, and the circuit having at least first and second basic branches connecting at first and second common points, the common points providing input and output for an AC driving current for the circuit. This circuit as well as others described and claimed herein incorporating various numbers of LEDs may be referred to herein as a “circuit module,” a “basic LED circuit,” or a “subcircuit,” given the fact that according to an aspect of the invention such circuits themselves may be joined with other such circuits in either basic or series relationships to each other. The first branch of the basic LED circuit has a first and a second LED, and the second branch having a third and a fourth LED. The first LED is connected to the second LED in opposing series relationship with the inputs of the first and second LEDs defining a first branch junction. The third LED is connected to the fourth LED in opposing series with the outputs of the third and fourth LEDs defining a second branch junction. The first and second branches are connected to one another such that the output of the first LED is connected to the input of the third LED at the first common point and the output of the second LED is connected to the input of the fourth LED at the second common point. At least one (or a first) cross-connecting circuit branch having at least a fifth LED is provided in an embodiment of the invention, the first cross-connecting circuit being configured such that the input of the fifth LED is connected to second branch junction and its output is connected to the first branch junction. It is important to note that according to an embodiment and aspect of the invention that circuits disclosed and claimed herein, result in an antibasic relationship of certain LEDs and further resulting in an imbalanced bridge effect in operation.

An AC LED bridge is an LED topology where the self rectifying property of anti basic LED strings is used to drive a set of ‘bridge’ LEDs with rectified current. An imbalanced bridge is the general implementation of this topology where one side of the input to the bridge has a different number of LEDs in series than the other side. A balanced bridge is a particular implementation of this topology where the input and output sides have equal numbers of LEDs in series. When used in a specific voltage drive regime, such as 12V AC, the advantage of an imbalanced bridge topology is that it can be constructed for example with standard GaN die so that the forward combined voltage of the die in one phase cycle is closely matched to the native supply voltage while the reverse voltage applied to the diodes in the opposing phase is kept to an acceptable level blow the reverse breakdown voltage of the die.

According to another embodiment of the invention, an AC-driven LED circuit may comprise one or more additional basic circuits each being the same as the first basic circuit identified above. Each additional circuit being conductively connected to the first basic circuit and to one another at the their common points for providing an input and an output for an AC driving current of the circuit. According to other embodiments, the additional basic circuits may be connected in series to the first basic circuit and to one another or the additional basic circuits may be connected in basic to the first basic circuit and to one another.

According to another embodiment of the invention, n additional LEDs, in pairs, may be provided in the circuit wherein the pairs are configured among the first and second branch circuits of each of the respective basic circuits or modules, such that current flows through the respective fifth diode of each basic circuit upon both a negative and positive phase of the AC driving source and so that the current draw through each of the respective basic circuits during both AC phases is substantially the same.

According to another embodiment the AC-driven LED circuit further comprises x cross-connecting circuit branches each having one or more LEDs and being configured such that current flows through each of the respective one or more LEDS upon both a negative and positive phase of the AC driving source and so that the current draw through each of the respective basic circuits during both AC phases is substantially the same.

According to an embodiments and aspect of the invention, the basic LED circuit and more complex circuits derived therefrom include a one or more of a resistor, a transient or surge protector, and a microfuse; in any number or combination respecting the needed or desired impedence, resistance, and/or drive current/voltage protection.

According to another aspect and embodiment of the invention, the circuit embodiments described and claimed herein are formed on a single semiconductor chip. Another embodiment and aspect of the invention provides that the circuits described and claimed herein including the LED die are formed on a sapphire substrate.

According to another embodiment of the invention, an AC-driven LED assembly comprises at least a first and a second LED each discretely packaged, the LEDs being connected in an AC circuit and each LED package being mounted to a substrate at a distance from the other of preferably approximately 3 mm or less, and more preferably 2.0 mm or less. In an embodiment the packaged LEDs also each have a length of preferably approximately 2.5 mm or less, and more preferably 2.0 mm or less. In an embodiment the packaged LEDs also each have a width of preferably approximately 2.5 mm or less, and more preferably 2.0 mm or less. In an embodiment the LED packages are arranged with respect to each other in a linear spatial relationship while in another embodiment the LED packages are arranged with respect to each other in an XY rectilinear spatial relationship.

### BRIEF DESCRIPTION OF THE DRAWINGS

FIG. 1 is a schematic view of an AC-driven LED circuit according to an embodiment of the invention;

FIG. 2 is a schematic view of an AC-driven LED circuit according to an embodiment of the invention;

FIG. 3 is a schematic view of an AC-driven LED circuit according to an embodiment of the invention;

FIG. 4 is a schematic view of an AC-driven LED circuit according to an embodiment of the invention;

FIG. 5 is a schematic view of an AC-driven LED circuit according to an embodiment of the invention;

FIG. 6 is a schematic top view of an AC-driven LED assembly according to an embodiment of the invention;

FIG. 7 is a schematic top view of an AC-driven LED assembly according to an embodiment of the invention; and,

FIG. 8 is a schematic side view of an AC-driven LED assembly according to an embodiment of the invention.

FIG. 9 is a schematic view of a modification to AC-driven circuit 70 of FIG. 4.

### DETAILED DESCRIPTION OF THE PRESENT INVENTION

While this invention is susceptible to embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated. Like components in the various FIGS. will be given like reference numbers.

FIG. 1 discloses an AC-driven LED circuit 10 including a first basic circuit 12 having a first branch 14, and a second branch 16. Branches 14, 16 connect at first common point 18 and second common point 20. The common points 18, 20 provide input and output for an AC driving current from a driver 24 for the circuit.

The first branch 14 has a first LED 26 and a second LED 28, and the second branch 16 having a third LED 30 and a fourth LED 32. The first LED 26 is connected to the second LED 28 in opposing series relationship with the inputs of the first and second LEDs 26, 28 defining a first branch junction 34. The third LED 30 is connected to the fourth LED 32 in opposing series with the outputs of the third and fourth LEDs 30, 32 defining a second branch junction 36.

The first and second branches 34, 36 are connected to one another such that the output of the first LED 26 is connected to the input of the third LED 30 at the first common point 18 and the output of the second LED 28 is connected to the input of the fourth LED 32 at the second common point 20. A first cross-connecting circuit branch 38 has a fifth LED 40. The first cross-connecting circuit branch 38 being configured such that the input of the fifth LED 40 is connected to second branch junction 36 and the output is connected to the first branch junction 34.

As will be appreciated by those of skill in the art, the LED's 26 and 32 will provide light only upon one half of an AC wave, pulse or phase, while LEDs 28 and 30 will provide light only upon the opposite wave, pulse or phase. At lower frequencies, e.g. mains frequencies, if the LEDs are spaced pursuant to another aspect of the invention (disclosed below) at preferably approximately 3.0 mm or less preferably approximately 2.0 mm or less, then the amount of noticeable flicker may not be unacceptable. However, the cross connecting circuit 38 and diode 40 will be on (produce light) in both phases of the AC drive and hence mitigate flicker which may be evidenced in its surrounding LEDs 26, 28, 30 and 32.

Advantageously the LED circuit 10 provides an LED topology an imbalanced bridge effect as one side of the circuit has a different number of LEDs in series than the other side. This characteristic is also disclosed in all of the circuits in FIGS. 1-9.

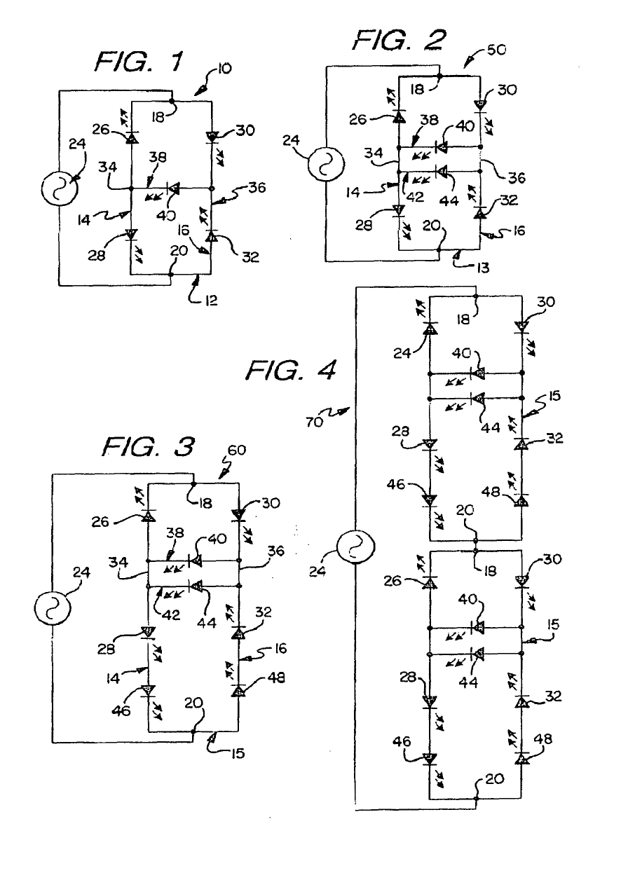

FIG. 2 discloses an AC-driven LED circuit 50 which is a modification of AC-driven LED circuit 10. Circuit 50 further mitigates flicker. Circuit 50 provides an additional cross-connecting circuit branch 42 having LED 44. The LEDS 40, 44 are configured such that current flows through each upon both a negative and positive phase of the AC driving source 24. It should be appreciated that according to the invention x number of such cross connecting circuit branches (such as 38, 42) may be added as desired, however, since the LEDs (such as LEDs 40, 44) are in basic with each other, their voltage demand will be divided while their current draw will not. Hence a suitable driver need be provided for this circumstance.

To increase the light output of the circuit of the invention, it should be noted as disclosed in FIG. 3 that additional or n LEDS may be provided in the branches 14 and 16. Specifically FIG. 3 discloses an AC-driven circuit 60 which is a modification of circuit 50. Circuit 60 provides for additional LEDs 46 and 48. The pair of LEDs are configured among the first and second branch circuits 14, 16 of the basic circuit 15 such that current flows through the respective diodes 40, 44 upon both a negative and positive phase of the AC driving source 24 and so that the current draw through basic circuit 15 during both AC phases is substantially the same.

It should be noted that according to the invention, n pairs of LEDs can be configured among first and second branch circuits of a respective basic circuit, such that current flows through the respective cross connecting circuit branch LEDs of a basic circuit upon both a negative and positive phase of the AC driving source and so that the current draw through each of the respective basic circuits during both AC phases is substantially the same. More LEDs in the branch circuits divide the current from the higher current LEDs in cross connecting circuits 38, 42.

According to another aspect of the invention, to further mitigate the amount of flicker perceived, adding to the light provided and to scalability, additional basic circuits, each being the same as the first basic circuit, may be conductively connected to the first basic circuit in series or basic at the their common points 18, 20 for providing an input and an output for an AC driving current for the circuit.

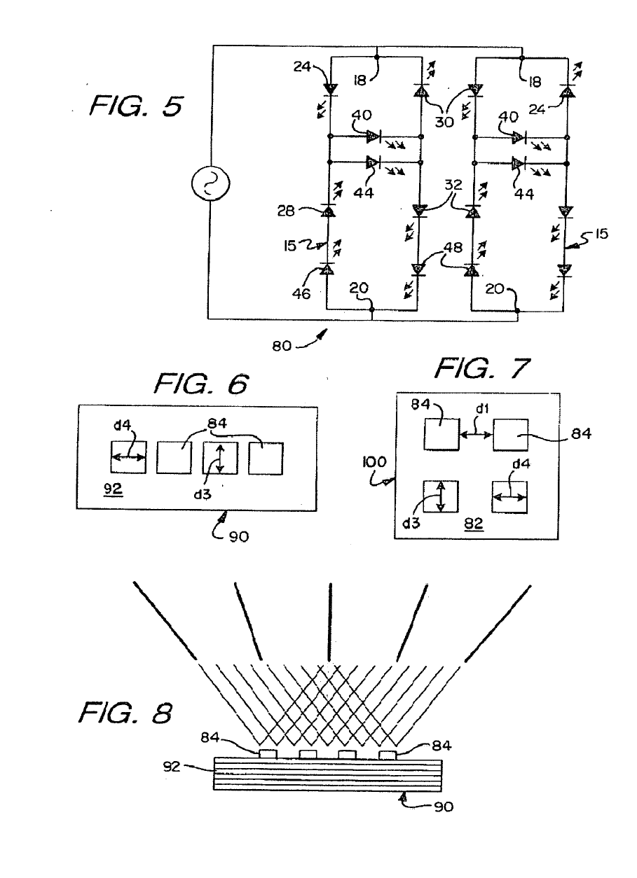

For instance, FIG. 4 discloses an AC-driven LED circuit 70 which includes additional basic circuits 15 connected in series at common points 18, 20. Additionally, as seen in FIG. 5, an AC-driven LED circuit 80 includes additional basic circuits 15 connected in basic at common points 18, 20. This embodiment shows the utility of providing a scalable circuit that can be manufactured modularly and used to connect to match higher voltage requirements e.g. circuit 15 may draw drawing 12 V AC while two such circuits 15 in series would meet 24V AC requirements.

Preferably, the number and type of LEDs in the AC-driven LED circuit draws a combined current and combined voltage which is substantially equal to the nominal voltage capacity of the AC drive source.

As shown in FIG. 6, an AC-driven LED assembly 90 has a first and a second LED 82 each discretely packaged, the LEDs being connected in an AC circuit and each LED package 82 being mounted to a substrate 92 at a distance d1 from the other of preferably approximately 3 mm or less, and more preferably 2.0 mm or less. The AC-driven LED assembly 90 also has packaged LEDs 84 each having a width d2 and a length d3 of preferably approximately 2.5 mm or less, and more preferably 2.0 mm or less.

FIG. 6 discloses an AC-driven LED assembly 90 wherein the LED packages 84 are arranged with respect to each other in a linear spatial relationship, while FIG. 7 discloses an assembly 100 wherein the LED packages 84 are arranged with respect to each other in an XY rectilinear spatial relationship.

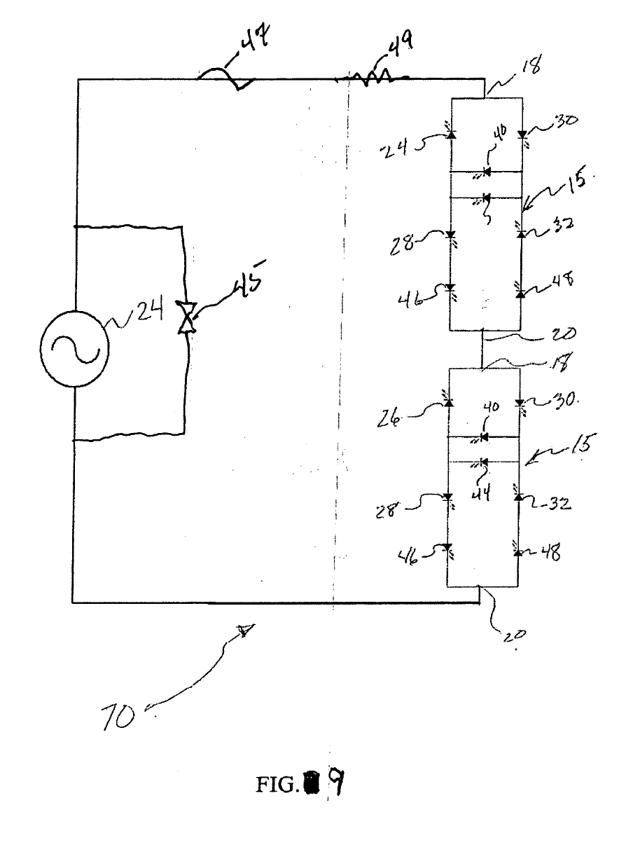

As can be seen in FIG. 8, when LED packages 84 are placed at 3 mm or less, the light produced therefrom intersects, thereby reducing or eliminating the effects of flicker.

FIG. 9 discloses a modification to AC-driven circuit 70 which according to the invention, whether embodied on a single chip, or to other another substrate or circuit board mounting, is provided with one or more at the option of the design criteria, to include one or more of a transient voltage suppressor 45 or like device, a micro-fuse 47, or like device (e.g. a PTC device) and a resistor 49. The resistor 49 may be unnecessary in a design where the resistance/impedance of the fusing and/or overvoltage devices are sufficient for the circuit performance.

According to the invention, the various embodiments of the basic LED circuits and larger circuits of serial and parallel arrangements of same are formed by forming the die/and or other circuit elements on a single semiconductor chip or a substrate, or mounted to substrates, and assemblies may be produced, such as creating an AC-driven circuit where all circuits and LEDs are formed on a semiconductor, where the LED are discretely packaged apart from the circuits, and where each basic circuit is formed on a printed circuit board. Preferably according to an aspect of the invention the basic circuits and larger circuits combining them may be formed on a sapphire substrate for thermal management of the numerous LED die.

While in the preceding there has been set forth a preferred embodiment of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying Claims.

I claim:

1. An AC-driven LED circuit comprising:
a first basic circuit having LEDs, each LED having an input and an output, and the circuit having at least first and second branches connecting at first and second common points, the common points providing input and output for an AC driving current for the circuit;
the first branch having a first and a second LED, and the second branch having a third and a fourth LED;
the first LED is connected to the second LED in opposing series relationship with the inputs of the first and second LEDs defining a first branch junction;
the third LED is connected to the fourth LED in opposing series with the outputs of the third and fourth LEDs defining a second branch junction,
the first and second branches are connected to one another such that the output of the first LED is connected to the input of the third LED at the first common point and the output of the second LED is connected to the input of the fourth LED at the second common point;
a first cross-connecting circuit branch having at least a fifth LED, the first cross-connecting circuit branch being configured such that the input of the fifth LED is connected to the second branch junction and the output is connected to the first branch junction; and,
wherein the first basic circuit is formed on a single semiconductor chip.

2. The AC-driven LED circuit according to claim 1 further comprising one or more additional basic circuits each being the same as the first basic circuit, each additional circuit being conductively connected to the first basic circuit and to one another at the their common points for providing an input and an output for an AC driving current for the circuit.

3. An AC-driven LED circuit according to claim 2 wherein the additional basic circuits are connected in series to the first basic circuit and to one another.

4. An AC-driven LED circuit according to claim 2 wherein the additional basic circuits are connected in parallel to the first basic circuit and to one another.

5. The AC-driven LED circuit according to claim 1 further comprising n additional LEDs, in pairs, wherein the pairs are configured among the first and second branch circuits of each of the respective basic circuits, such that current flows through the respective fifth diode of each basic circuit upon both a negative and positive phase of the AC driving source and so that the current draw through each of the respective basic circuits during both AC phases is substantially the same.

6. The AC-driven LED circuit according to claim 1 further comprising, for each basic circuit, x cross-connecting circuit branches each having one or more LEDs and being configured such that current flows through each of the respective one or more LEDS upon both a negative and positive phase of the AC driving source and so that the current draw through each of the respective basic circuits during both AC phases is substantially the same.

7. The AC-driven LED circuit according to claim 1 wherein the number and type of LEDs of the AC-driven LED circuit draw a combined current which is substantially equal to the nominal current capacity of the AC-source.

8. The AC-driven LED circuit according to claim 1 wherein the number and type of LEDs of the AC-driven LED circuit drops a combined voltage which is substantially equal to the nominal voltage capacity of the AC-source.

9. The AC-driven LED circuit according to claim 2 wherein the first basic circuit and each other basic circuit has a voltage drop of twelve volts.

10. (canceled)

11. The AC-driven LED circuits of claim 1 wherein the LEDs are discretely packaged apart from the circuits.

12. The AC-driven LED assemblies of claim 11 wherein each basic circuit is formed on a printed circuit board.

13. The AC-driven circuits of claim 1 further comprising one or more of a transient voltage suppressor device, a fuseable element, and a resistor.

14. An AC-driven LED circuit comprising:
a first basic circuit having LEDs, each LED having an input and an output, and the circuit having at least first and second branches connecting at first and second common points, the common points providing input and output for an AC driving current for the circuit;
the first branch having a first and a second LED, and the second branch having a third and a fourth LED;
the first LED is connected to the second LED in opposing series relationship with the inputs of the first and second LEDs defining a first branch junction;
the third LED is connected to the fourth LED in opposing series with the outputs of the third and fourth LEDs defining a second branch junction,
the first and second branches are connected to one another such that the output of the first LED is connected to the input of the third LED at the first common point and the output of the second LED is connected to the input of the fourth LED at the second common point;
a first cross-connecting circuit branch having at least a fifth LED, the first cross-connecting circuit branch being configured such that the input of the fifth LED is connected to the second branch junction and the output is connected to the first branch junction; and,
wherein the arrangement of the LEDs provide an imbalance bridge effect to the basic AC-driven circuit and one or more of a transient voltage suppressor device, a fuseable element, and a resistor is attached to the first basic circuit.
